(19) United States
(12) Patent Application Publication
(10) Pub. No.: US 2014/0330739 A1
(43) Pub. Date: Nov. 6, 2014

(54) Optimizing Customer Delivery Services

(71) Applicant: Gruppo Due Mondi, Inc., Wakefield, NH (US)

(72) Inventors: Richard Falcone, Wakefield, NH (US); John J. Viola, Frisco, TX (US); Dennis J. Reinhold, Dallas, TX (US)

(73) Assignee: Gruppo Due Mondi, Inc., Wakefield, NH (US)

(21) Appl. No.: 14/020,874

(22) Filed: Sep. 8, 2013

Related U.S. Application Data
(63) Continuation of application No. 13/875,205, filed on May 1, 2013.

(51) Int. Cl. G06Q 10/08

(52) U.S. Cl. CPC G06Q 10/08355
USPC 705/338

(57) ABSTRACT

Systems and methods for delivering items to customers are disclosed. In one embodiment, an initial delivery schedule is established. The delivery schedule comprises a plurality of slots representing delivery times and delivery locations for the customers, wherein the slots are assigned as a result of a collaborative process. A set of pre-selected additional customers are identified for possible scheduling of any open slot. In real-time, additional slots in the initial delivery schedule are automatically identified. The additional slots represent a capacity to provide the item to one or more additional customers. One or more target customers are contacted to fill the additional slots. The target customers are automatically selected from the set of pre-selected additional customers based upon a target customer location relative to delivery locations associated with the slots adjacent to the additional slot. Customers may also pick up items from a delivery vehicle parked at a centralized location.

### CROSS-REFERENCE TO RELATED APPLICATIONS

The present application is a continuation of, and claims the benefit of the filing date of, U.S. patent application Ser. No. 13/875,205, filed May 1, 2013, the disclosure of which is hereby incorporated herein by reference in its entirety.

### BACKGROUND

Many products and services require delivery to customers at multiple locations. For example, courier and shipping services, such as Federal Express or UPS, deliver packages to many customer locations. Delivery trucks are loaded with packages for delivery to customers' homes or businesses. The trucks are typically loaded in the morning, and then the driver follows a pre-selected route based upon the destination home and work addresses. The truck drivers leave the appropriate packages at each address. If the intended recipient is not available, the driver may keep the package and will attempt delivery at another time or will require the addressee to pick up the package at a central shipping location. The actual routes followed by the delivery trucks change daily, but are set when the trucks are loaded and do not change thereafter. The delivery time for each package is not scheduled, but instead depends upon the recipients order in the route selected for that day. Because the delivery locations change often and are not known well in advance, it can be difficult to efficiently schedule these package deliveries.

In another well-known delivery scenario, consumers may order pizza, sandwiches, or other food from restaurants for delivery to home or work. In the case of pizza delivery, for example, customers place their orders and drivers take the pizzas out for delivery as the orders are ready. The orders are typically not scheduled for a particular delivery time. Instead, the customer is given an estimated time when the order will be ready. Although the restaurant may know through experience approximately how long it will take to prepare the food and when an order will be ready after it is placed, the actual delivery timing is almost random because it depends up on the availability of a delivery driver, traffic conditions, geographic location, and how many orders each drivers handles. The customer's receipt of the completed order depends upon the distance from the restaurant to the destination address, the number of available drivers, the number of current orders, the number of orders each driver takes for delivery, traffic and weather conditions, and other factors.

Another food delivery service is the catering truck or mobile food truck. For many years, the “lunch wagon” has been a common presence at worksites, such as construction areas and factories. These catering trucks carry a large variety of coffee-break and lunchtime staples and typically follow a somewhat standardized route among certain worksites. The trucks stop at each site for as long as is needed to serve that day's customers. The routes change as the customers' demands vary. When a construction site wraps up or if there is little demand at particular factory, the driver will drop the business and look for alternative locations. Consumers are subject to the driver's route choice, and there is generally no capability to schedule or request a catering truck visit, place an order for pick-up or delivery, or track the status of an order. Additionally, demand for the catering truck's goods is usually limited to a few time periods throughout the day, such as in the morning before workers punch-in, during coffee breaks, and at lunchtime. Outside of those time periods, the catering trucks are typically out of service and make few, if any, sales.

More recently, so-called gourmet food trucks have become commonplace. These trucks aim to provide high-end and/or specialty food to consumers outside of a typical restaurant experience. Gourmet food trucks are often targeted at an urban or professional demographic and, therefore, are typically found in business, museum/arts, or nightlife districts that are not served by regular catering trucks. The gourmet food trucks may also be found in other public areas, such as parks or beaches, where they might overlap with catering truck offerings. The gourmet food trucks may appear in a different location every day but usually visit only one or two locations each per day. Because of the “pop-up” nature of the gourmet foods trucks' location, consumers are not able to request delivery from these food trucks or to schedule a location for the food truck on a particular day. In some cities, certain areas are designated in which several gourmet food trucks are allowed to park for long periods of time, such as weeks or months. These food trucks operate more as fixed restaurants that service whoever shows up each day at that location.

### SUMMARY

In one embodiment, a company offers products for delivery to customers. A customer requests delivery at a particular time (i.e., orders products). The company evaluates the request and determines whether to accept the order or to propose an alternative time if the order cannot be filled at the time requested by the customer. The company and the customer use a collaborative process to reach a mutual agreement on a committed and acceptable time for delivery of products. In other embodiments, the customer may schedule orders to be picked up the company.

The customer places an order request for a desired time. The customer understands that at the time the order is first placed, the company has not yet committed to fulfilling the order. After analysis by the company and based upon on many factors, the company may accept the order and then inform the customer that the requested order has been converted to a committed order. Factors considered by the company, as to whether or not the requested order becomes a committed order include, for example, the number of orders actually placed or anticipated for that time period, whether the orders are for pick-up or delivery, the locations of the deliveries and pick-ups, traffic and weather conditions, the capacity of the company at various points in time, and varying supply and demand requirements.

After considering these factors, the company may determine that it cannot meet the customer's delivery or pick-up expectation. In that case, the company may suggest an alternate time to the customer. The company and the customer—either through a single step or through several iterations—will attempt to arrive at a committed time that is acceptable to both the customer and the company. Generally, the company will propose and accept committed times only if it has a high likelihood of meeting the requested delivery or pick-up time. Using this approach, the parties may convert a highly random process into a more sensibly managed collaborative process that allows the company to more consistently meet the customer's expectations.

Where the company visits a number of customers to make deliveries or pick-ups, route optimization is used to minimize dead time between visits. Additionally, the company continually stimulates demand to fill any open time slots. In one embodiment, management of the company's schedule is a two-part process of initialization and ongoing management. Both parts of the process have the same business goals, which are to maximize revenue while minimizing costs and to meet the customers' timing and other expectations.

### BRIEF DESCRIPTION OF THE DRAWINGS

Having thus described the invention in general terms, reference will now be made to the accompanying drawings, which are not necessarily drawn to scale, and wherein:

FIG. 1 is a high level block diagram illustrating a system for providing an automated optimization/collaboration application to a delivery service operator.

FIG. 2 illustrates the databases, tables, or other information stored in memory for use by the automated optimization/collaboration application.

FIG. 3 illustrates an example target market schedule for an automated optimization/collaboration application according to one embodiment.

FIG. 4 illustrates an example weekday schedule for an automated optimization/collaboration application according to one embodiment.

FIG. 5 illustrates an example product requirements table for an automated optimization/collaboration application according to one embodiment.

FIG. 6 illustrates timing considerations for an individual order according to an example embodiment.

FIG. 7 illustrates a timeline for a residential delivery schedule for an automated optimization/collaboration application according to one embodiment.

FIG. 8 illustrates a geographic distribution of the orders and the expected drive time between the orders.

FIG. 9 is a timeline that shows current orders and illustrates the effect of the drive-time and delivery times for potential customers.

FIG. 10 is a flowchart of a method for optimizing a delivery schedule according to one embodiment.

FIG. 11 illustrates a user interface for identifying potential locations for sales calls.

FIG. 12 illustrates user interface that is displayed when the user selects one of the proprieties on a map.

FIG. 13 illustrates an integrated delivery platform according to one embodiment that provides delivery services to multiple markets.

### DETAILED DESCRIPTION

The invention now will be described more fully hereinafter with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. One skilled in the art may be able to use the various embodiments of the invention.

For purposes of illustration, an example embodiment of the invention is described in detail herein to explain various features, configurations, and alternatives. This example may be generally described as a food delivery truck that includes the capability to cook food at or on the way to a customer location. The food delivery truck operator may use an automated optimization/collaboration application that provides customer interface, delivery scheduling, and business generation tools. As a result, the operator is able to provide food delivery on a “just-in-time” basis wherein the customer's food completes cooking at approximately the same time as the delivery truck arrives at the customer's location or the truck arrives at the location with sufficient time to prepare the food before a scheduled delivery.

The food delivery truck is also capable of operating in a temporary fixed location. It will be understood that the invention is not limited to this example embodiment and that other delivery services, such as other food delivery and package delivery services, may also use the techniques disclosed herein. Additionally, multiple services or products may be offered in one delivery. For example, the food delivery truck may be capable of baking pizzas, cooking pasta, chicken wings, or desserts, and delivering pre-prepared food.

Embodiments of the invention establish a new approach to customers using interactive, mobile technology to manage delivery of items, such as food, to the customers. The approach described herein provides a managed process that allows an operator to negotiate a mutually agreed upon delivery time with the customer. The delivery time may be a specific time (e.g., at 6:00 PM), a delivery window (e.g., deliver between 6:00 PM and 6:15 PM), a delivery deadline (e.g., no later than 6:00 PM), or any other appropriate time parameters. It will be understood that this approach will also support scheduling of item pick-up from a customer, such as picking up packages from a customer location at an agreed upon time. The process allows the customer to act as the decision maker who accepts a guaranteed delivery time that the operator has offered in response to an initial customer request. For example, in response to a customer request for a delivery at particular time, the process evaluates the operator's capability to meet that delivery time in view of existing commitments and other requests. If the operator can meet the requested time, then the customer is offered that delivery time. If the operator cannot meet the requested time, then the process identifies one or more alternative delivery times and offers those times to the customer. The customer may or may not accept the offered alternative, or may request another delivery time. If a mutually agreed upon time cannot be met, then the operator may offer the customer a discount or other incentive to place another order at a later time.

The processes described herein are designed to be customer-relationship oriented so that the customer is satisfied and receives his or her delivery at an acceptable time. At the same time, the processes are designed to improve business performance so that the operator can maximize the volume and size of deliveries while minimizing route time and operating expense. This may require the operator to decline requested deliveries if they are relatively small compared to other requests (i.e., decline delivery of a single item in favor of another multiple-item delivery) or if they are for a route-inconvenient location (i.e., a location that is distant from other requested deliveries and that would impact the total number of deliveries that the operator could make). The processes described herein provide a strategic business platform that is optimized to maximize revenue while achieving the lowest possible operating expense (OpEx) and capital expense (CapEx) per dollar of revenue.

In one embodiment, the operator may be assigned to a particular territory. The operator uses an interactive customer ordering and scheduling system to establish delivery times for customers within the territory. The operator may serve different sub-markets within the territory, such as business customers, residential customers, and special events customers, at different times of the day or on different days of the week. The interactive customer system is based upon an intelligent delivery platform that uses artificial intelligence that enables the operator and customers to make informed decisions. The system is dynamic in that it continuously processes new information so that the operator and customers can make real-time decisions. The system is also interactive so that the operator and customers can continuously interact with the system and each other. The system may send the customers a photo of the operator prior to delivery as a safety factor.

The platform intelligently manages delivery-route time or “windshield time” in real-time to optimize financial performance on a per-hour basis. The operator may use the platform to generate additional delivery orders using targeted customer stimulation. Potential customers and existing customers receive notifications over a variety of media (such as email, text, telephone calls, etc.) of delivery opportunities. For example, if the operator is scheduled to make a delivery at a particular location, notifications are sent out to targeted customers who live or work within a specified range of that location. The notification informs the targeted customers that a delivery is being made in their area and that they can add their own order at standard or discounted prices. Cross-customer stimulation is also supported by the platform. Scheduled customers may notify potential customers of a scheduled delivery and may receive incentives or discounts for any additional orders requested by those potential customers. Loyalty incentive programs may be offered by the operator to leverage lunch-to-dinner and dinner-to-lunch sales stimulation.

In one embodiment, the items delivered to the customer are prepared en route or at the customer location. For example, the customer may order food to be delivered at the mutually agreed upon time. The operator may either cook the food while driving to the customer location or may use commercial ovens to quickly cook the food upon arriving at the customer location. The ability to receive hot, freshly cooked food, such as a bubbling hot pizza, at the customer's own location appeals to a market segment that is not satisfied with existing food delivery services that provide food that has been cooling and losing freshness while traveling to the customer location. Similarly, other perishable, limited-lifetime, or limited-use items may be constructed en route or at a customer location.

The intelligent delivery platform is continuously operating in the background to receive customer requests, schedule as many requested delivery times as possible, collaborate with customers to find a mutually agreeable time when requested times are unavailable, and increase the number of orders by targeting potential customers. Using these techniques to manage the number of existing and targeted customers, resolve schedule conflicts, and minimize delivery route time, the platform optimizes the operator's financial performance per unit of delivery work time to provide the best financial outcome while maintaining high customer satisfaction.

The customer ordering process is automated and, therefore, the customer may order at any time. The platform accepts customer order information, such as contact information, delivery location, and requested delivery time. The customer identifies a preferred delivery time, which could be for a specific time (e.g., 6:00 PM) or for a range of times (e.g., anytime from 6:00-6:30 PM). The delivery time may be for the same day or for a future date. By compiling all relevant order information, the platform will build a baseline route plan that is optimized to minimize windshield time between deliveries while meeting requested delivery times as much as possible.

In one embodiment, the platform initially accepts the order as a tentative request and informs the customer that the order will be confirmed or further negotiated at a later time. The platform will accept tentative orders until a threshold is met to generate a pool of requests as the input to a route-planning algorithm. The threshold may be, for example, a predetermined time or a predetermined number of orders. Once the threshold is met, the platform builds the baseline route plan using the pool of requests. The platform decides which customer requests to confirm and which customer requests to negotiate. For confirmed requests, the platform sends out customer commitment time notifications. Once the request has been confirmed, the operator has guaranteed that the delivery will be made at the requested time. The operator may offer some type of compensation, such as a discounted price or coupon for future deliveries, if the requested and confirmed time is not met.

The intelligent delivery platform may determine that some requests cannot be confirmed. When request conflicts occur, such as two or more customers request the same delivery time at different locations, the platform may use any appropriate method to decide which request should be confirmed. The platform may select the first request received, the request for the largest or most profitable order, or a request that is the best fit in the baseline route plan.

Route conflicts may also occur when a requested delivery location is too far from the other pending requests. For example, if most of the requests are for one section of the operator's territory and another request is on the opposite side of the territory, it may have an negative economic impact if the inconvenient location is served due to increased route time to serve that customer (i.e., excess “windshield time”).

The platform notifies the customers with requests that the operator cannot satisfy (i.e., conflicted customers) that their original request is not accepted and offers an alternative time. The alternative time may be a time that is as close as possible to the original request and that does not negatively impact the baseline delivery route for confirmed orders. The conflicted customers may accept the alternate time or may counteroffer with other delivery times. It will be in the customers' control to eventually accept or decline an alternative delivery time after one or more proposals. If the customer's request cannot be accepted and no alternative can be agreed upon, the operator may offer the conflicted customer some incentive, such as coupons or discounts, to place a future order.

In some embodiments, another operator may be notified of the conflicted customers. Generally, the operators work in assigned territories. If an operator cannot service all of the customers in his or her territory, then that operator may open the un-served customers to service by operators from other territories. In this way, an operator can maximize his use of the territory and fill his schedule, but if there are additional customers to serve, then additional help may be brought in to ensure that as many customers as possible are satisfied. As an incentive to sharing excess customers, the assigned operator may receive a portion of the sales by other operators who enter the territory.

After the baseline delivery route plan is built at the threshold time, the platform will continue to accept additional requests. Those additional requests will be processed (i.e., confirmed and added to the delivery route or counter-offered to negotiate an alternative delivery time) as they are received. The additional requests may be accepted before the delivery route has begun or while the delivery vehicle is on the route and making scheduled deliveries.

For example, an operator may determine that he or she is going to start the delivery route at 6:00 PM and wants to know the initial route at 3:00 PM. The platform may accept pending requests until the threshold time of 3:00 PM. At that time, the baseline delivery route plan will be built for the current pool of requests. The system will continue to accept new delivery requests until the operator starts the route at 6:00 PM. Those new delivery requests will be accepted or negotiated depending upon whether they can be added to the baseline route plan. When the delivery vehicle is on the route after 6:00 PM, more new requests can be received and will be accepted based upon the vehicle's current location and/or whether the more new requests can be added to the existing route plan.

Once the baseline route plan is created, such as at 3:00 PM in the example above, the platform will begin stimulating additional requests from targeted customer groups. These targeted customer groups may be selected, for example, based upon the delivery locations on the baseline route plan. The platform maintains a database of customer information. The customer database includes current, past and potential user information and is populated with data collected from past orders, business data sources (e.g., chamber of commerce information), residential data sources (e.g., white pages), and interested consumers who provide their own information.

In one embodiment, potential customer information can be collected by the operator when making deliveries. The delivery vehicle may have a wireless access point that allows the integrated delivery platform to interact with current and potential customers and other interested users. A potential customer may send his or her information to the platform using text, email, telephone, or a smartphone application via the wireless access point. The information may include telephone numbers, email addresses, social media identifiers, home and work physical addresses, and/or other contact data. When interested users observe the vehicle making a delivery, for example, they may send their contact data to the platform, which loads the information to the customer database.

The intelligent delivery platform may identify different targeted customer groups. One group is associated with existing delivery locations. Once the baseline route plan has been established, the platform looks for potential customers who are located at or near confirmed delivery locations. Those potential customers receive a notification of the delivery vehicle's availability at a particular confirmed location at the previously agreed upon time. This would allow additional orders to be placed for services to be delivered to additional customers at the same location, thereby increasing sales without incurring any additional “windshield time.” For example, if a food delivery truck is going to be at a business location at lunchtime, then the platform may search for potential customers who live or work near the business location. Similarly, if the food delivery truck was going to be at a residential location at dinnertime, then the platform may search for potential customers who live on the same block or in the same sub-division or neighborhood.

Another group of potential customers are selected based upon “holes” in the baseline route plan. If the travel time between two consecutive delivery locations in the baseline route plan is shorter than the time between the confirmed delivery times at those locations (e.g., travel distance is 15 minutes, but delivery times are 30 minutes apart), then the platform may target potential customers at either the start or end delivery locations or along the route between the locations. Targeted customers may be offered delivery of the services at a time that will fit within the baseline route plan and not require rescheduling of confirmed deliveries.

The targeted customers may receive a text, email, telephone call, or other communication that identifies the location and time of a proposed delivery, as well as real time updates concerning timing, including delays to the delivery time caused by traffic conditions, and unforeseen circumstances. For example, a notification may identify the delivery vehicle's location at a particular time or period (e.g., “service is available at 123 Main St. from 11:00 AM-1:00 PM” or “we have a delivery in your neighborhood at 6:00 PM”) and prompt the potential customer to place an order (e.g., “place your lunch order for pickup” or “we can add your order to our schedule”).

Additional business generation may originate with the customers themselves. For example, a customer with a confirmed order may be able to notify their contacts, such as family, friends, and neighbors, of the order and suggest that the contacts add their own order. In other embodiments, a customer may be able to access the platform to see if orders have already been placed for his or her neighborhood and may add their own order for a time that fits in with the existing scheduled.

Various incentives may be offered to confirmed and potential customers to promote additional order stimulation activity, such as discounts on the price of current orders if referred customers place an order or discounts for placing an order that is compatible with an existing confirmed order.

Once an order has been confirmed and the delivery vehicle has begun the delivery route, the platform will provide feedback to the customers to keep them updated on the status of their orders (e.g., confirming delivery times). If the vehicle falls behind on the planned delivery schedule or if the GPS indicates there is excessive traffic or delays that will impact delivery time, customers may be notified in real-time, via text, email, or telephone, of changes in the delivery times. The intelligent delivery platform may use a GPS or other navigation tracking system on board the delivery vehicle to identify the current vehicle location and compare it to an expected route location at that time.

As noted above, the intelligent delivery platform may be used to serve different sub-markets within an assigned territory. In one embodiment, for planning purposes, the operator may designate different times of the day or on different days of the week to serve specific market segments. The scheduling for these different market segments may vary depending upon the amount of preplanning required or available. For example, the operator of a food delivery truck may plan on serving a business market for weekday lunch and coffee break services, serving a consumer market for evening dinner services, and serving special event and entertainment markets on an as-available or as-required basis. The business market may be scheduled in advance, preferably for repeating visits, such as lunch service on a particular day each week or month. The consumer market is likely scheduled on a daily basis depending upon consumer demand. The intelligent delivery platform may be used to stimulate additional orders in addition to confirmed customer requests for any of these markets. For example, if a food delivery truck operator has confirmed a lunchtime service at a particular business, then the platform may notify nearby contacts of the appointment and invite them to also use the services at that time and location.

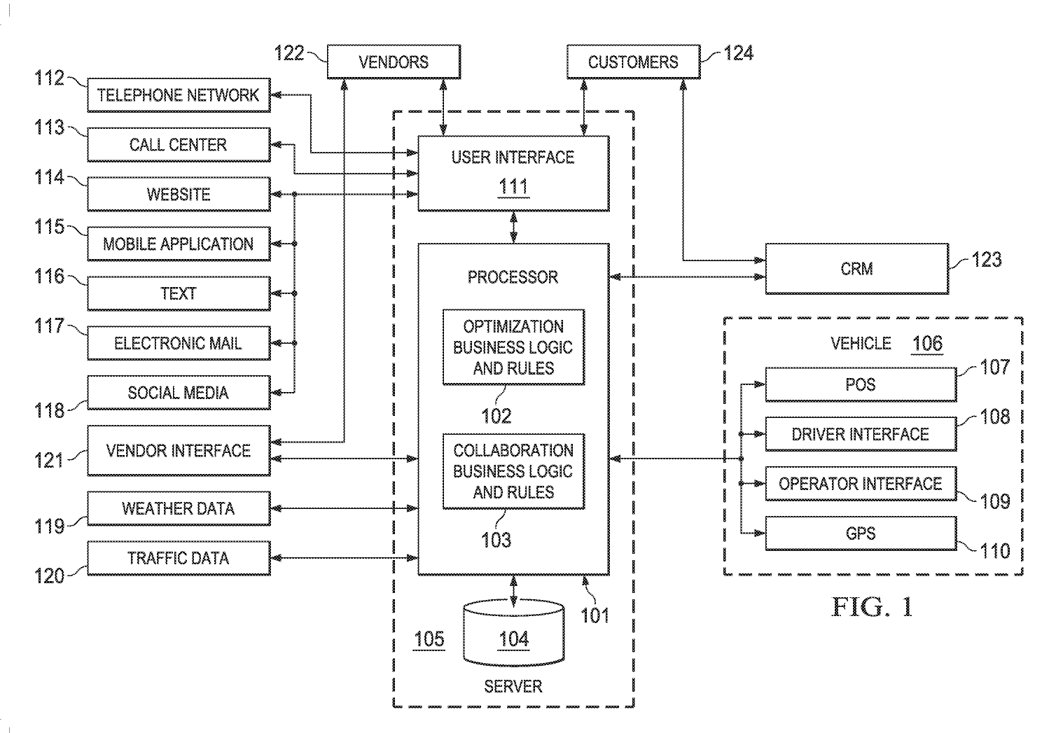

FIG. 1 is a high level block diagram illustrating a system 100 for providing an automated optimization/collaboration application to food delivery truck operators. A software or firmware application runs on a processor 101, which may be any logic circuitry configured to execute software code or program instructions. For example, software code for optimization business logic and rules 102 and collaboration business logic and rules 103 may run on processor 101. Software code and other data that is required by the automated optimization/collaboration application are stored in a database or memory 104, which may be any form of volatile or non-volatile electronic storage, such as a hard drive, cache, RAM, ROM, or flash memory. In some embodiments, the components, such as processor 101 and memory 104 are in a fixed location, such as on a server 105. In other embodiments, the components may be located on-board the food delivery truck or other vehicle 106. The components may communicate via direct or networked connections, such as wired connections or wireless connections supported by a packet-switched local area or wide area network.

Processor 101 is connected to a point of sale (POS) system 107 that is used to facilitate customer transactions, process credit and debit charges, and track customer orders. A driver interface 108 provides output, such as route information, to the food delivery truck driver. Driver interface 108 may provide information in various formats, such as printed driving directions or a visual display. Driver interface 108 may be coupled to a vehicle navigation or telematics system to provide visual route information on a map display and/or audible driving cues to the driver. Operator interface 109 provides order information, cooking instructions, and other directions to the staff in the food delivery truck who are cooking the food and other products. These instructions may identify, for example, the items in a customer's order and indicate when the items should be prepared. A navigation system, such as GPS 110 may be used to track the food delivery truck's current location, which allows the system to constantly update routing in order to avoid accidents, heavy traffic, and other potential delays.

POS system 104, driver interface 108, operator interface 109, and GPS 110 may be mobile components that are located on a delivery truck 106. These may be separate components or combined into one or more devices. In some embodiments, the other components, such as processor 101 and memory 104, may also be located on the food delivery truck. In other embodiments, the processor 101 and memory 104 are embodied in a fixed location such as a server 105. A plurality of delivery trucks 106, such as fleet of trucks controlled by the same operator or a number of independent trucks, may use the same central server 105.

User interface 111 provides customer and operator access to system 100 via one or more technologies. The operator and customers may communicate by telephone via a telephone network 112 and/or call center 113. Alternatively, the customers and operator may communicate electronically, for example, via an Internet web site 114, mobile device application 115, text message system 116, electronic mail 117, or social media application 118.

Additional information may be available to processor 101 and to the software code for optimization business logic and rules 102 and collaboration business logic and rules 103, such as weather data 119 and traffic data 120. The weather data 119 may include forecast and current weather that is used to schedule future deliveries and to adjust drive times and routing for current deliveries. Similarly, the traffic data 120 may be used to determine delivery routes and to calculate estimated delivery times. The system 100 may also use the traffic data to reroute the delivery truck as updated traffic conditions are reported.

System 100 may also allow the user to access a vendor interface 121 that is used to place orders for new products and supplies. Vendors 122 may use vendor interface 121 or user interface 111 to access the system and/or to provide data, such as for supplies, products, stock, inventory, or other information.

The user may also access a customer relationship management (CRM) system 123. CRM 123 may be used to manage interaction with customers 124. The customers 124 may also access the system via user interface 111, such as to request service, place orders, provide contact information, view product information, update requests, verify order status and the like.

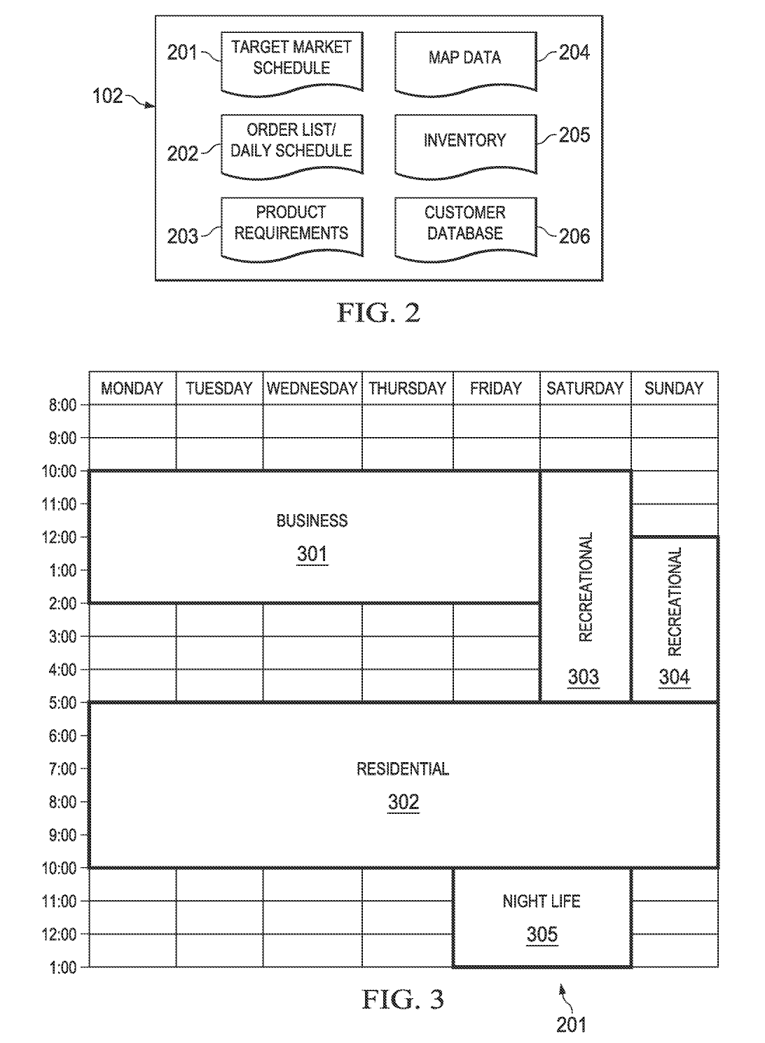

FIG. 2 illustrates some of the databases, tables, or other information stored in memory 104. Target market schedule 201 is an overall weekly or monthly plan for the operator that identifies the types of customers the operator wants to target. Order list/daily schedule 202 tracks the operator's actual schedule for the day, which may be updated in real-time as new customer orders arrive. Product requirements table 203 is a list of items associated with the food or products offered by the delivery truck. Map data 204 provides detailed address and street information that the system uses to determine routes, calculate delivery times, and identify current and potential customers. Inventory list 205 is used to track the stock on board the food delivery truck. This information is used to determine the type and number of products that the truck can provide and to identify when the truck needs to be restocked.

Customer database 206 includes information on past, current, and potential residential and business customers. The customer database 206 includes contact information, such as customer address, telephone numbers, email addresses, etc. This database may also include historical purchase data, such as products ordered, amounts spent, days and times of purchases, that can be used to identify when the customer may be most likely to order again. The customer database may include additional information for business customers and commercial locations, such as a number of employees at a given location, work schedules for the location, availability of other food at a given location, etc.

In one embodiment, the food delivery truck is part of a franchise business in which a franchisee or operator purchases, rents, or leases the food delivery truck along with access to the automated optimization/collaboration application. The operator may contract to use the food delivery truck and the automated optimization/collaboration application in a defined market, such as in a particular neighborhood, region, city, state, and/or other geographic region. The operator may be limited to a defined market segment within a region, such as business customers, residential customers, particular types business or residential customers, and/or special events. The operator may further contract to use the food delivery truck and the automated optimization/collaboration application in a defined time period, such as anytime, lunchtime, dinnertime, weekdays, weekends, a particular number of hours per day, week or month, or a specified range of hours, days, or weeks.

The food delivery truck may be used in a number of different scenarios. During the day on weekdays when most adults are at work and most children are in school, the truck may serve businesses, schools, or other locations where a number of people are interested in purchasing food for lunch at lunchtime or for a snack during a break. At night, when families tend to be at home, the truck may target its service to homes and residential neighborhoods. On weekends, the truck may serve different other areas, such as parks, beaches, pools, athletic facilities, stadiums, sporting events, picnics, fairs, festivals, and various recreational facilities. Accordingly, the food delivery truck's schedule and mode of operation will vary during the day and from day-to-day. The automated optimization/collaboration application is aware of these different modes of operation and is adapted to handle these

FIG. 3 illustrates an example target market schedule 201. The operator may define the types of markets that he or she wants to pursue on different days and at different times. This information may be used by the automated optimization/collaboration application to identify and pursue potential customers, as discussed in additional detail below. For example, the operator may plan on serving businesses during lunchtime on weekday mid-day 301 generally. Weekday and weekend evenings 302, the operator will target residential customers during dinnertime. On weekends, the operator may target recreational areas during the mid-day 303 on Saturdays. This may include special events, such as fairs, festivals, or other infrequent or one-time events.

On Sundays, the operator also target recreational areas, but may define a shorter period 304 that starts later and finishes earlier accounting for families that attend church in the morning and are home in the evening to get ready for work/school on Monday. Sunday evenings may also be designated to target residential customers 302. On Friday and Saturday nights 305, the operator may target areas with a lot of nightlife, such as bars or nightclubs, for service in a fixed or “pop-up” location to serve slices to individual customers.

The automated optimization/collaboration application can use this target market information 201 to assist the operator in building a delivery schedule and to optimize sales in the target market. For example, during weekdays, the operator schedules service at one or more businesses each day during block 301. Unlike a catering truck, the food delivery truck does not just show up at a business. Instead, the operator schedules the stops in block 301 with the businesses ahead of time and advertises the stops to the business's employees. The operator may schedule a different business every day of the week so that visits to the same business occur at weekly or monthly intervals. In the evening, the operator delivers food to residential customers during block 302.

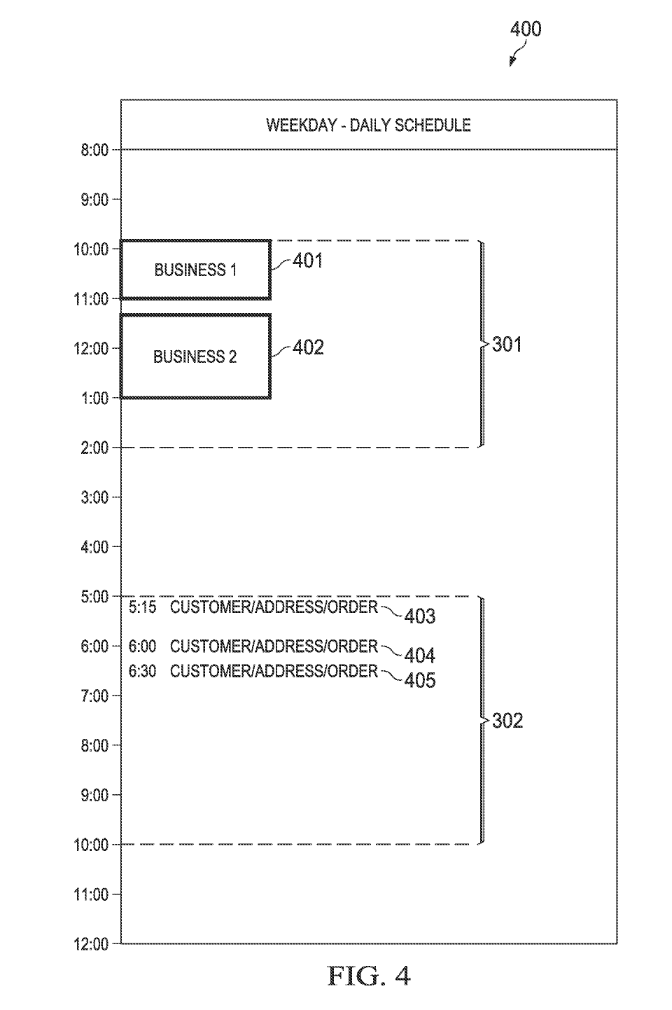

FIG. 4 illustrates an example weekday schedule 400. During the mid-day period 301, the operator has scheduled stops 401, 402 at two businesses. For example, the delivery truck may make a first stop at Business 1 during a morning break period 401, and then stops at Business 2 during lunchtime 402. The operator's goal for these business stops 401, 402 may be a high volume of individual sales at one location. This goal is enhanced by visiting different businesses each day and likely not returning to the same business more frequently than weekly or longer so that the customers at each location will not grow tired of the product. When business cancelations occur, the operator will attempt to fill the open slots by contacting other business, such as recently visited businesses, potential new clients, and former clients, and offering to schedule the now-available cancelation slot.

The automated optimization/collaboration applications may track the sales at each business location and apply analytics to evaluate whether the visits to that location are occurring too frequently or if it might be worth visiting the location more frequently. If sales are dropping off during weekly visits, then the application may indicate that the operator should move the visits to every other week or a longer interval. If sales are steady over a series of monthly visits, the application may indicate that the operator should increase the visits to twice a month or even weekly visits. The application may also determine that alternative days should be tried (i.e., instead of visiting less frequently, the operator should visit on a different day of the week).

During an evening period 302, the food delivery truck may serve residential customers. These visits are likely to be scheduled on the same day that delivery is required. The lead-time for these orders may vary such that an initial group of orders may be received in the morning from customers who are planning ahead, and then more requests coming in the afternoon as other customers finalize their dinner plans. As these individual orders 403-405 are received, the application works interactively with customer either directly (e.g., through a mobile device application or on an Internet web site) or indirectly (e.g., through the operator or a call center operator who enters the customer's order into the application). Individual, residential customer orders may keep coming in throughout the evening so that the operator and the application have to adjust and update the schedule in real-time.

The automated optimization/collaboration application works to fill openings in schedule 400 during the evening residential period 302 in order to optimize usage of the food delivery truck. For example, there is a 45 minute block open between the first residential customer 403 and the next customer 404. As discussed in more detail below, optimization business logic and rules 102 use customer data 206 and attempts to generate business to fill any openings in the schedule. Additionally, new customers may call the operator to order food for delivery during the day and while the delivery truck is out making deliveries. The collaboration business logic and rules 103 work with these new customers to identify a mutually agreeable time for delivery. Ideally, the automated optimization/collaboration application generates sufficient new business and coordinates new customer orders so that the delivery truck drives from one destination to another stopping only long enough to make a delivery with minimal dead time waiting to start the next order/delivery.

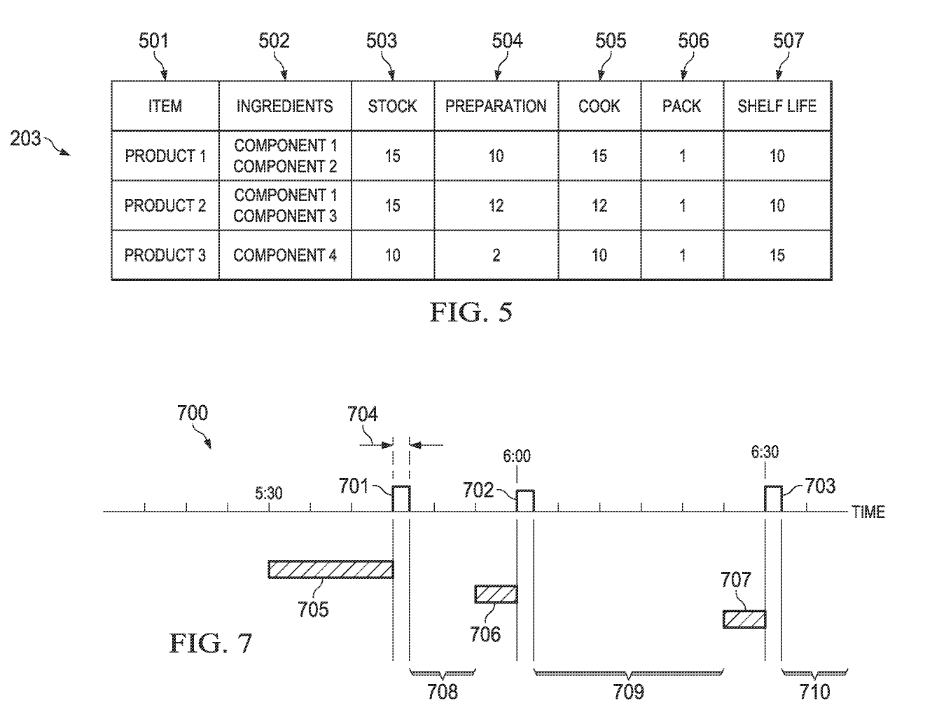

Because a goal of the automated optimization/collaboration application is to complete orders as the truck arrives at a customer destination, the system needs to know how long it takes to prepare the items ordered by the customer. FIG. 5 illustrates an example product requirements table 203. The list of products 501 offered by the delivery truck are included in the table. For each product 501, there is a list of required ingredients 502. This information may be compared to a current inventory list 205 to determine if the delivery truck has the capability of making the product at the current time.

For each product 501, there is also a list of required times that may be used to determine when to prepare the items in a customer's order. The example illustrated in FIG. 5 includes a complete list of all times associated with a particular product. For example, the time 503 required to stock or restock the delivery truck with the ingredients for each product is included. This may be useful to determine whether or not the delivery truck has time to restock between customers or to determine when the operator needs to begin getting the truck ready before the first order of the day.

A preparation time 504 indicates the average time required to collect the product ingredients and get them ready to cook. For example, if product 1 is a pizza, then ingredients 502 may list dough, cheese, sauce, and various toppings required for the pizza. Preparation time 504 indicates how long it takes to combine those ingredients so that they are ready to go into an oven and bake. This time may vary, for example, depending upon whether the operator is rolling out pizza dough from scratch for each order, or if the dough is already prepared.

Cook time 505 is the amount of time required to cook or bake the product. A number of cook times may be listed for each order to reflect various levels of “doneness” if that is an option offered to the customer. Alternatively, each product 501 may correspond to a specific cook time so that a “rare” product is entered on one line and a “well done” product is entered on another line. Packing time 506 indicates the time required after the product has been cooked to remove it from the oven, for example, and package the product for delivery. This package time 506 may be very short, such as taking a pizza out of an oven and putting it in a box. However, for other items, such as desserts that need to be frosted or combined after cooking, packaging time 506 may take longer.

Although one goal of the automated optimization/collaboration application is to arrive at a customer location just as the product is ready to deliver, it is possible that the truck will be late due to traffic or other unforeseen problems. Shelf life 507 is included to indicate how long a product can be kept after it is ready for delivery. This value may account for keeping a product hot, such as under a heat lamp or in a warming oven, or for product that are served at room-temperature or refrigerated. The shelf life value 507 may be used to determine if a new product should be prepared so that the customer does not receive an order that is spoiled or below a minimum desired quality level.

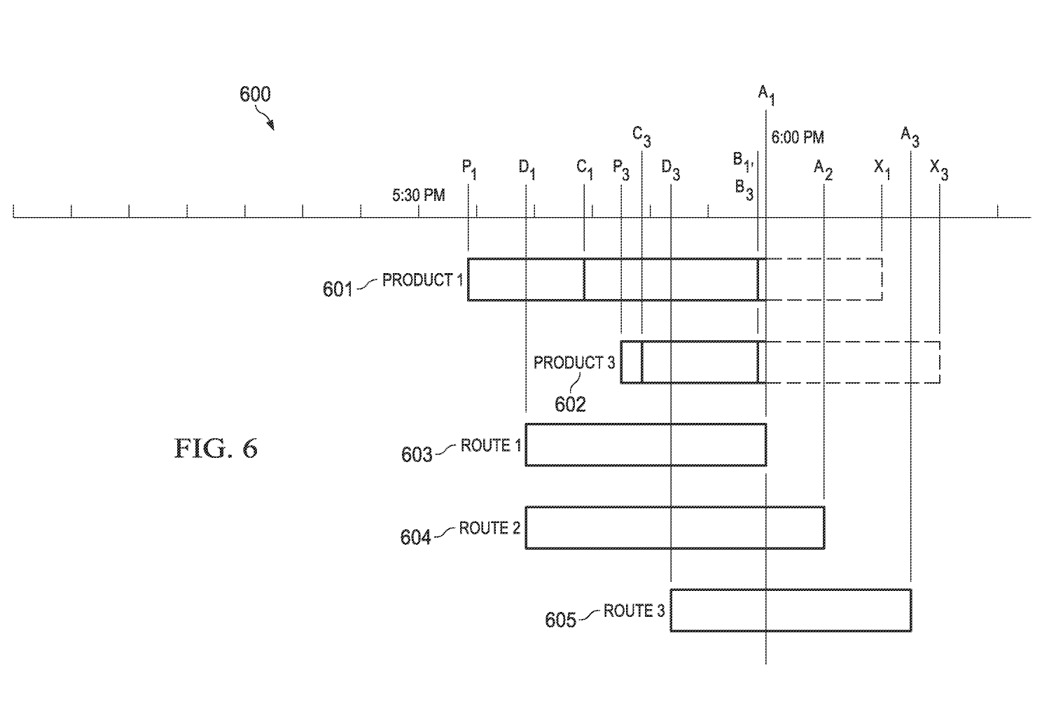

FIG. 6 illustrates timing considerations for an individual order according to an example embodiment. When a customer places an order, the automated optimization/collaboration application generates an expected delivery timeline 600. For example, if a customer's order included product 1 and product 3 from table 203 (FIG. 5) for delivery at 6:00 PM, then the automated optimization/collaboration application targets 6:00 PM and works backwards to determine when the products need to be prepared and cooked and when the delivery truck needs to be driving to the customer's address.

Using the prep 504, cook 505, and packaging 506 times in table 203 as an example, the automated optimization/collaboration application determines the timeline 601 for product 1. In order for product 1 to be ready for delivery at 6:00 PM, the operator must begin preparing product 1 at time P1 (5:34 PM), start cooking product 1 at time C1 (5:44 PM), and remove product 1 from the oven to be boxed or packaged at time B1 (5:59 PM). In the timeline 602 for product 3, the preparation time starts at P3 (5:42 PM), cooking starts at C3 (5:44 PM), and packaging at B3 (5:59 PM). Once products 1 and 3 are boxed, they have a shelf life of X1 (6:10 PM) and X3 (6:15 PM), respectively.

This delivery timeline 600 along with the order list and times may be provided to the operator or cook in the pizza delivery truck via the operator interface 109 (FIG. 1). This information may be presented as a printed document and/or as text, graphics or icons on a display screen.

The automated optimization/collaboration application may adjust the preparation times in certain circumstances. For example, when both product 1 and product 3 are scheduled to be removed from the oven and boxed at the same time (B1, B3), then the instructions to the operator for preparing one of the products may be adjusted so that two events for the same order do not occur simultaneously. In one embodiment, the automated optimization/collaboration application adjusts the timeline for one of the ordered products (e.g., by moving the timeline for a product up or back 30 seconds or 1 minute) so that the operator can perform each action at the scheduled time. The automated optimization/collaboration application may determine which timeline to adjust using the shelf life value (507). In the example of FIG. 6, product 3 has a longer shelf life. So the timeline 602 for product 3 may be moved forward so that product 3 is removed from the oven and boxed before product 1. Product 3 will still have an acceptable quality when delivered to the customer in this scenario.

Delivery timeline 600 also includes a route timeline 603 that is determined based on the truck's current location, which may be determined by GPS 110 and the destination address. Independent of the cooking instructions and preparation timeline calculations 601, 602, the automated optimization/collaboration application generates route instructions for the truck driver. The route instructions may be provided to the driver via a driver interface 104, such as printed driving directions and/or routing displayed on a vehicle navigation or telematics system.

Route timeline 603 indicates when the truck needs to begin driving to the customer location in order to arrive no later than the 6:00 PM delivery time. Route timeline 603 may take into account current conditions based upon weather data 119 and traffic data 120.

Assuming that the driver begins the route by time D1 (5:39 PM), and the operator follows the preparation timelines 601, 602, the truck will arrive (A1) at the customer location at the agreed delivery time as the order is being boxed. The order may be presented to the customer, and customer payments collected via POS system 104. Completion of the order is reported to the automated optimization/collaboration application, and the pizza delivery truck may begin driving to the next customer destination.

It is expected that the truck will occasionally be delayed so that it does not arrive at the desired arrival time A1 (6:00 PM). This may occur, for example, due to delays caused by unexpected traffic or vehicle problems. Additionally, delays can be created at a previous customer location if the previous order was not ready on time or if the previous customer was not ready to receive an order at the agreed upon delivery time. As a result, the truck may not leave the previous location in time to meet the next delivery deadline.

Timeline 604 illustrates the situation in which the delivery truck is delayed by traffic, for example. The truck began its route at the appropriate time D1, but delays in route have extended the truck's arrival to a new time A2. Route 2 604 may be the same physical route as route 1 603, but recalculated to compensate for slower speeds (e.g., the truck stuck in traffic near an accident). Route 2 604 may also represent a new, longer physical route (e.g., recalculated on different streets to avoid an accident).

Timeline 605 illustrates the situation in which the drive time remains the same (i.e., no traffic or weather delays on the route), but the truck did not begin the route until time D3 due to delays at the prior customer location. As a result, the truck will not arrive at the next customer location until time A3.

In the timeline 604 example, the traffic delay will result in the products being ready at the agreed upon time A1, but not delivered until the delayed arrival time A2. In this situation, the products are still within their acceptable shelf life X1, X2 and, therefore, they can still be provided to the customer.

In the timeline 605 example, the delayed start will result in product 1 exceeding its shelf life X1 when the truck finally arrives at the destination at time A3. Depending upon when the automated optimization/collaboration application recognizes this problem, it may be handled in different ways. In one embodiment, the automated optimization/collaboration application re-analyzes or recalculates the original product preparation timelines when a delay is detected. The delay may be detected if the truck does not begin the route at time D1, or when the agreed upon delivery time has been reached without completion of the sale, or by periodically recalculating the route timeline.

FIG. 7 illustrates a timeline 700 for a residential delivery schedule with three orders that are currently on the schedule at 5:45 PM (701), 6:00 PM (702), and 6:30 PM (703). Assuming the truck arrives for each delivery at the scheduled time, the truck will be at the delivery location for some period of time 704 while the customer picks up and pays for the order. Each of the deliveries 701-703 may be assigned a default delivery time, such as 2 minutes as shown on timeline 700. Depending upon the destination, such as the neighborhood, type of building, available parking, and other considerations, the delivery time 704 for particular orders may be adjusted to account for likely delays. Other factors, such as size of the order, may also increase the likely delivery time 704.

Timeline 700 also illustrates expected drive times 705-707. The drive times 705-707 represent the expected time required to drive from one order location to the next. For the first order, the drive time 705 the start location may be set to the operator's home location or to a standard starting point. For the other drive times 706 and 707, the drive time is calculated based on travel time between each order. For example, drive time 706 represents the drive time from the location of order 701 to the location of order 702. The drive times 704-707 are aligned with the ending locations on each delivery leg.

Timeline 700 can be used to identify areas where additional orders may be filled. For example, if customers called and placed orders 701-703, then the automated optimization/collaboration application may attempt to generate other orders during the “holes” 708 and 709 in the schedule.

The automated optimization/collaboration applications recognize that order 701 should be complete by 5:47 PM and that order 702 should be delivered at 6:00, which allows for 13 minutes for the truck to drive between the locations of orders 701 and 702. However, the expected drive time 706 is only 5 minutes, so there are 8 extra minutes (708) available in the schedule. In a similar fashion, 23 extra minutes (709) are identified as available between orders 702 and 703.

In one embodiment, additional customers may call the operator to place an order. The collaboration business logic and rules 103 interact with new customers to fit their requested order into one of the open regions or “holes” in the current schedule. A new order request may be characterized in several ways. The new order request may directly conflict with the time of an existing order 701-703, or it may fall within an expected drive time 705-707 of an existing order, or it may fall within one of the open regions 708, 709 between current orders, or in an unscheduled area 710 after the last current order 703.

If the requested new order directly conflicts with a current order, then the collaboration business logic and rules 103 will decline the requested time and will propose an alternative time. If the requested new order falls within a drive time 706, 707 or in one of the open regions 708, 709, then the automated optimization/collaboration application will determine if the new order can be serviced. The new order will be accepted if the products requested, the delivery location, and the delivery time will not disrupt the existing schedule 700. When an alternative time is required, the collaborative business logic and rules 103 will work with the new customer and attempt to come to a mutually agreeable time that fits in the delivery timeline 700.

In addition to scheduling new customer-initiated orders using the collaboration business logic and rules 103, the optimization business logic and rules 102 proactively attempts to generate new orders that will fit into the delivery timeline. The optimization business logic and rules 102 must first identify potential customers and then contact them to propose a delivery.

The delivery truck has a set inventory when the schedule begins each day or each delivery period. The inventory defines how much of each product can be prepared and delivered without replenishing inventory. The delivery truck cannot generate more product than stock on hand unless the delivery driver has a sufficient open time slot in order to replenish inventory. Accordingly, when customers call in orders, the automated optimization/collaboration application takes into account whether the delivery truck can fill the order (i.e., the inventory will be available on the truck at the requested time and has not been committed to later orders that day).

The process for identifying potential system-initiated orders by the optimization business logic and rules 102 may be similar to the process that collaboration business logic and rules 103 use to evaluate whether new customer-initiated orders can be filled. One of the key considerations for these new orders is the new delivery location and its relationship to the existing orders. The excess schedule times 708, 709 are available for additional drive time and additional delivery time. Accordingly, the duration of each block of excess schedule time further limits the ability to accept new orders. The system may set a minimum excess schedule time that is required to add new orders between existing orders to avoid over-scheduling the delivery truck. For example, the 8 minute excess duration 708 between orders 701 and 702 may be too short, but the 23 minute excess duration 709 is likely to be long enough to fit in one or more additional orders.

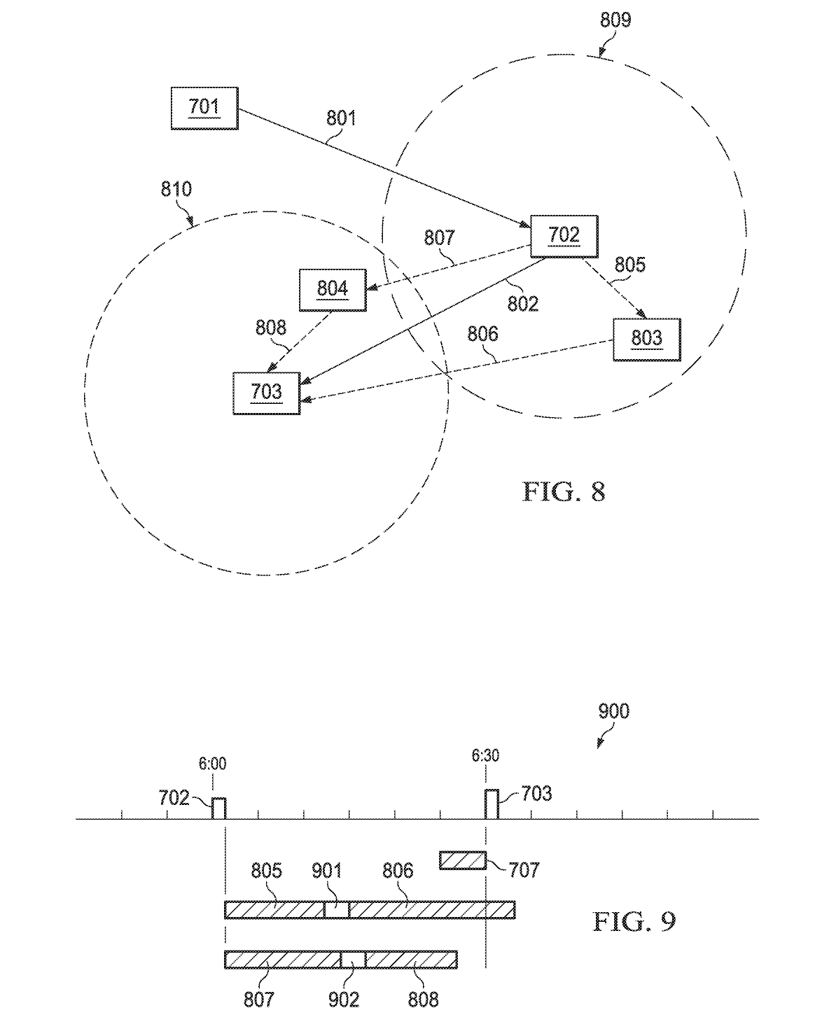

FIG. 8 illustrates a geographic distribution of the orders 701-703 and the expected drive time 706, 707 between the orders. Although shown as direct lines 801, 802, the automated optimization/collaboration application may consider the actual route taken between orders, which would have to follow the actual street layout. However, for purposes of identifying potential new orders, the schedule may be modeled as shown in FIG. 8.

Route 802 between orders 702 and 703 requires only 5 minutes (707), and 23 excess minutes (709) are available. Accordingly, an additional order may be serviced between orders 702 and 703 if the drive time and delivery time for a new order will not make the delivery truck late for order 703.

The automated optimization/collaboration application identifies two potential customers 803, 804 for system-generated new orders. The system may identify potential new orders from a database 206 that includes contact information and prior order information for past customers and/or contact information for potential customers who have indicated an interest in the products. The list of customers may be narrowed by considering potential customers that fall within an area 809 around the location of order 702 and/or an area 810 around the location of order 703. Areas 809 and 810 may be defined by a certain radius around locations 702, 703. In other embodiments, the potential customers may be limited to the group of potential customers who live on or within a certain distance of route 802 between locations 702 and 703.

To serve potential customer/order 803, the truck will follow route 805 from order 702 to order 803 and then follow route 806 from order 803 to order 703. Alternatively, to serve potential customer/order 804, the truck will follow route 807 from order 702 to order 804 and then follow route 808 from order 804 to order 703.

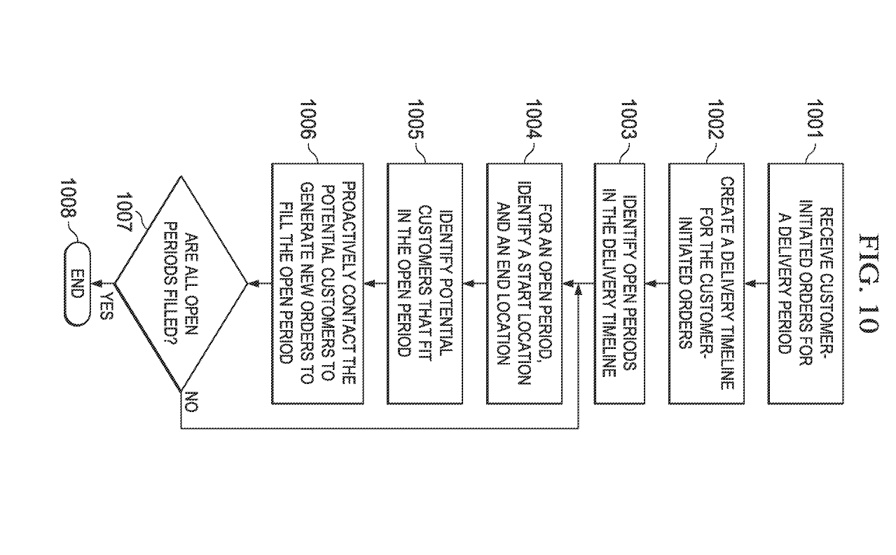

FIG. 9 is a timeline 900 that shows the current orders 702, 703 and illustrates the effect of the drive-time and delivery times for potential customers 803, 804. If the delivery truck serves customer 803, then the drive times 805, 806 to and from the location of customer 803 plus the delivery time 901 at customer 803 will exceed the available time between orders 702 and 703. Accordingly, customer 803 cannot be served without disrupting the original schedule. Therefore, the optimization business logic and rules 102 will not proactively contact customer 803 on this day.

If the delivery truck serves customer 804, then the drive times 807, 808 to and from the location of customer 804 plus the delivery time 90 at customer 804 can be accomplished the available time between orders 702 and 703. Therefore, the optimization business logic and rules 102 may proactively contact potential customer 804 and will attempt to generate a new order. The system may contact potential customer 804 directly by telephone 112, text message 114, electronic mail 115, or social media 116, for example.

FIG. 10 is a flowchart of a method for optimizing a delivery schedule according to one embodiment. In step 1001, an automated optimization/collaboration application receives orders from customers. The orders for a particular delivery period, such as a certain day, are grouped together. In step 1002, a delivery timeline is created for the orders received from customers. The timeline is analyzed and, in step 1003, open periods in the timeline are identified.

In step 1004, start and end locations are identified for one of the open periods. Potential customers for the open period are identified in step 1005. The potential customers must fit in the open period such that additional orders from the potential customers will not adversely affect the existing schedule. In step 1006, the potential customers are contacted to generate new orders to fill the open period. In step 1007, the process evaluates whether all of the open periods have been filled. If not, then the process continues at step 1004 to fill the remaining open periods. Otherwise, the process ends at step 1008.

In another embodiment, an operator may not be able to schedule deliveries for all customer requests. The operator may instead offer to schedule a pick-up order for customer, wherein customer may pick-up the order from a delivery vehicle. The pick-up order may be scheduled for a delivery time and delivery location that was previously scheduled for another customer. If the pick-up customer is unable to make the pick-up at another scheduled customer's location, then the pick-up can be scheduled for a pick-up time at a fixed or centralized location or at some other location not otherwise scheduled for a delivery.

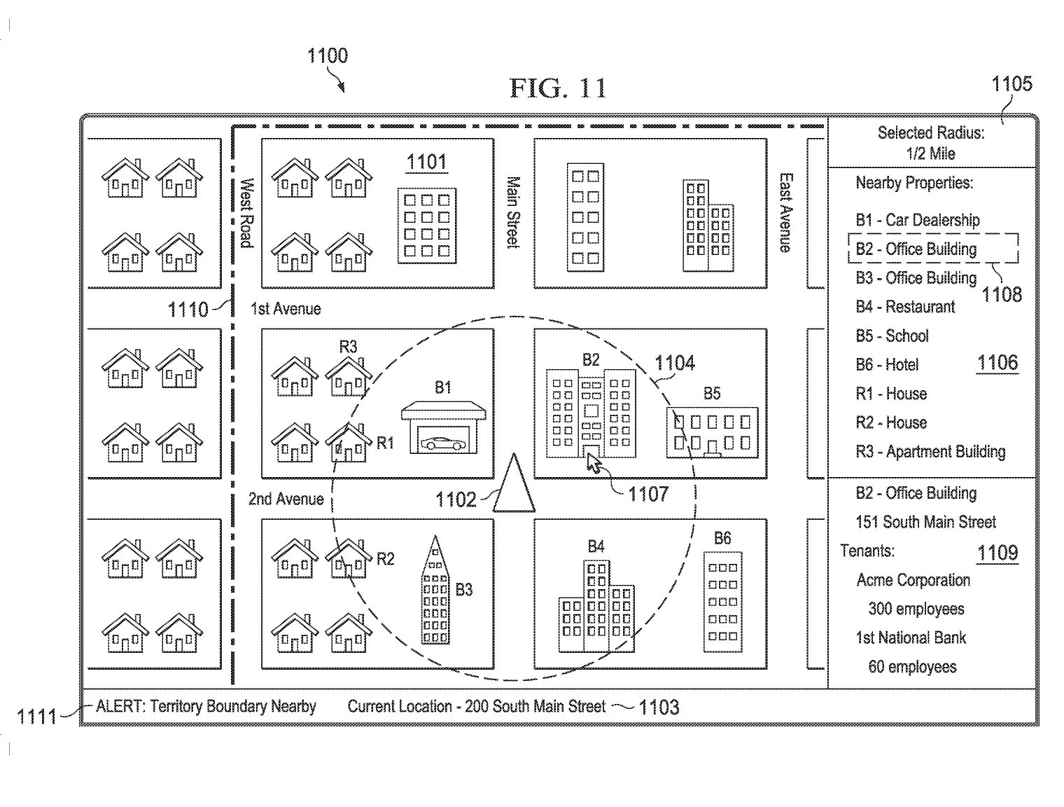

FIG. 11 illustrates a user interface 1100 for identifying potential locations for sales calls. The sales calls may be related to any product or service. For example, in an example used herein, the sales may be for a food and other products sold by a food truck. User interface may be part of a computer application for identifying potential sales locations and for scheduling sales calls. The application may be hosted on a centralized server that the user accesses remotely, such as an Internet-based or web-based application. Alternatively, the application may be hosted on the user's computer, laptop, tablet, smartphone, or the like. The application may be used in a fixed location, such as a desktop computer, or while the user is mobile, such as a laptop, tablet, or smartphone.

User interface 1100 displays a map 1101 of a selected area. In one embodiment, the selected area is tied to the user's present location. For example, based on the user's location as determined by GPS coordinates, a map 1101 is selected and displayed. The user's location 1102 may also be displayed on the map. If the user is in a vehicle, such as a food truck, and is moving, then the user's location 1102 is updated on the map 1101 periodically. Map 1101 may be centered on the user's location and the map may move on the display 1100 as the user moves. Data for the user's current position may be displayed, such as an address, GPS coordinates, or other information 1104.

The user defines an area of interest on map 1101, such as an area within a certain distance of the user 1102. The area of interest is defined and shown on the map using boundary line 1104. The user interface allows the user to select the radius 1109 of the area of interest. In other embodiment, the area of interest may have other shapes, such as a square or rectangle, or may correspond to a selected number city blocks, a zip code, an area code, or other geographical feature.

Map 1101 displays the location of residences and businesses. For example, a house icon or symbol may be used to show the location of residences, such as homes, condominiums, dormitories, or apartment buildings, and a building icon or symbol may be used to show the location of office business, hotels, restaurants, schools, or any commercial building. In other embodiments, more specific icons or symbols may be used to identify different types of facilities, such as a schoolhouse for a school, a cross for a church, an “H” for a hospital.

The user interface highlights or otherwise marks properties that are located within the area of interest 1104. As illustrated in FIG. 11, residences located within the area of interest 1108 are marked as R1, R2, or R3 and business in that area are marked as B1 through B6. Those properties are also listed in a detailed information section 1110 on the right side of the display.

The user interface may also show geographic or other boundaries 1110. The boundary 1110 may indicate an assigned sales territory, a region covered by a business license, a political boundary (i.e., a city, county or state line), or other restrictive or advisory limit. In the scenario where boundary 1110 represents a licensed region or sales territory limit, the user interface may provide a warning or other alert 1111.

The user may select a property of interest, such as building B2, using a mouse or other pointing device 1106 and “clicking” on the property shown on map 1101. Alternatively, the user may highlight, click, or otherwise select the property in list 1106. When a property is selected, detailed property information for that property is shown in section 1109.

If the selected property is a building, then the detailed information may include, for example, the name of the building, a building address, the number of floors, the amount of space in the building, the name of building tenants, a number of employees for each tenant or for the building as a whole, etc. Other details that are relevant to the user's product may also be displayed. For example, for a food truck user, the detailed information may show work hours for the building, the presence of a restaurant or café in the building, or information about the closest restaurants and fast food locations.

User interface 1100 may allow the user to select a particular tenant listed for the property. More detailed information may then be shown for the selected tenant, such as a telephone number, email address, website address, or other contact information. The user may then contact the business to set up a potential sales call or to schedule a visit to the property.

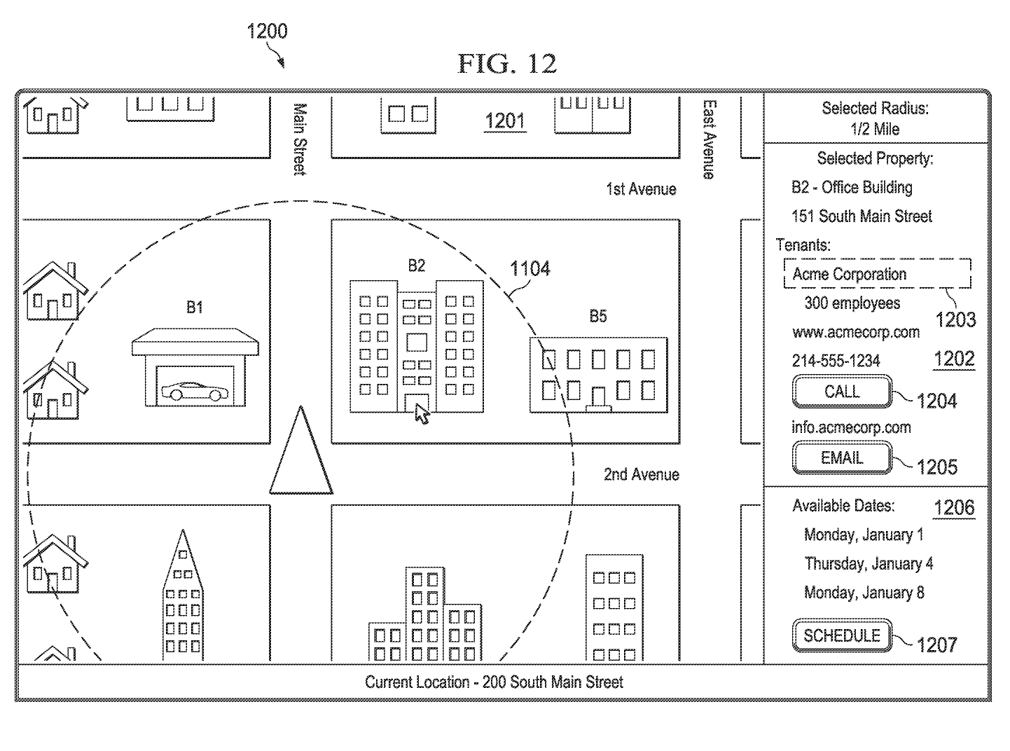

FIG. 12 illustrates user interface 1200 that is displayed when the user selects one of the proprieties on map 1101, such as building B2. The map 1201 zooms in on building B2 and detailed property information is displayed in section 1202. The detailed information 1202 includes, for example, a type (e.g., office building, school, residence, etc.), an address, and a list of tenants. The user can select one of the tenants 1203 to get additional detailed information about the selected tenant. For example, a web site, phone number, and email contact.

User interface 1200 also provides a call button or icon 1204 that initiates a call to the selected tenant. The user can also select email button or icon 1205 to initiates an email to the selected tenant. For example, in the case of a food truck service, the user interface 1200 would allow the user to identify potential locations for current or future sales. Using the property and tenant information 1202 the user can evaluate whether or not the location is a good prospect for food truck sales. The user can select call button 1204 to initiate a call to the tenant or select email button 1205 to initiate an email to the tenant to get additional information about the location, set up a meeting, or schedule a food truck visit.

Schedule section 1206 lists available dates and times for the user. For example, the dates listed in section 1206 may be open times when the food truck is not currently scheduled. After calling or emailing the tenant, the user can schedule a food truck visit by selecting button or icon 1207 to initiate a schedule process.

The information shown on the map may be a simple street map view or may be a satellite view. Other views, such as an aerial view or birds-eye view may also be available to provide the user with additional information about a selected property. The user may want to look at a potential customer location to identify possible parking locations, building layout, or other features of the location.

The user interface may use one or more databases to collect information for display. A mapping database may be used for street map and/or satellite view pictures to be displayed based on a current location or selected property. One or more business database may also be used to collect tenant information and contact information. Other databases, such as demographic information, census data and secretary of state business data, may also be accessed to collect information for the user.

In other embodiments, the user may select a residence R1-R3 (FIG. 11) to get information about a particular residential property or neighborhood, such as property values, income levels, population density, and other demographic information, as well as past order data (including frequency of orders, dollars spent, items ordered, whether discounts were given to generate the order, etc.), or other information that may be useful to evaluate potential sales locations. The user interface 1200 may also provide contact information for the selected residence to allow the user to call 1204 or email 1205 the resident and/or schedule 1207 a visit or other meeting.

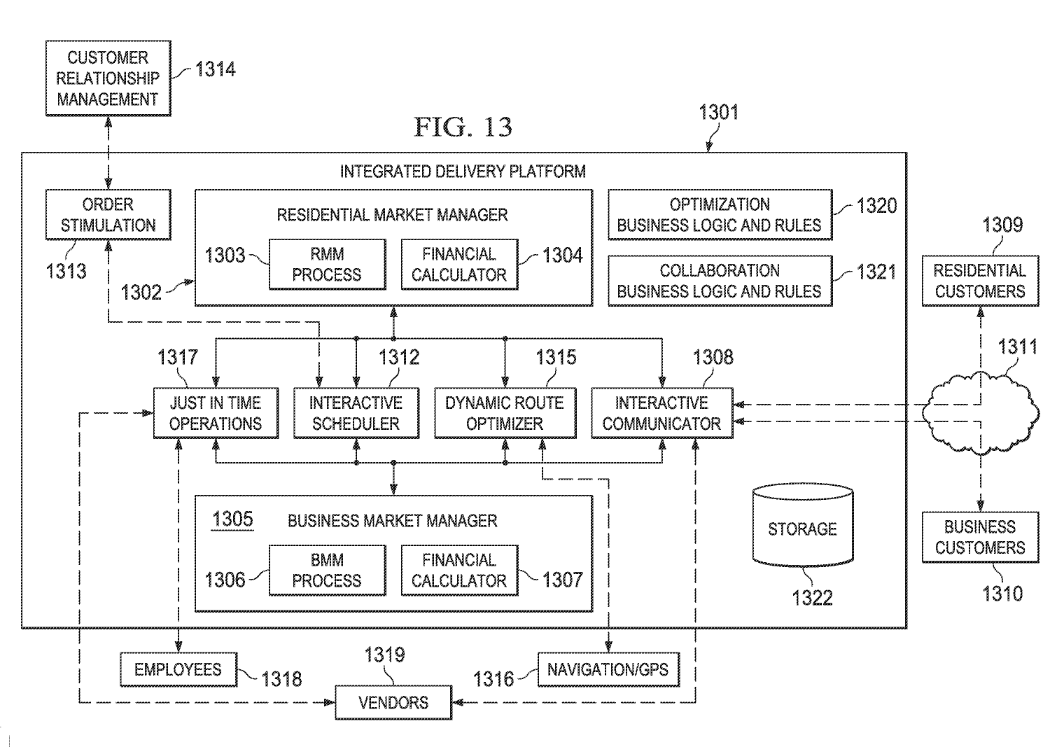

FIG. 13 illustrates an integrated delivery platform 1301 according to one embodiment that provides delivery services to multiple markets, such as a residential market and a business market. The integrated delivery platform 1301 may be comprised of a number of software modules or components running on a processor-based system, such as a server or a desktop, laptop, or tablet computer. The residential market may include, for example, customers who order for deliver to homes, apartments, dormitories, and other single- or multi-unit dwellings. The business market may include, for example, single business locations, office towers, shopping centers and malls, educational institutions, hospitals, and other commercial and non-residential locations. It will be understood that platform 1301 may serve a single operator and/or single delivery vehicle or may serve a plurality of vehicles belonging to one or more operators.

A residential market manager module 1302 is responsible for managing data, schedules, territories, and interactions for residential customers. A residential market manager (RMM) process sub-module 1303 provides intelligence for the residential market and controls how and when deliveries to this market occur. Financial calculator sub-module 1304 is configured to provide economic analysis specifically for the residential market so that the residential market manager can maintain optimal financial performance when committing to customer orders and selecting delivery routes. Similarly, a business market manager module 1305, business market manager (BMM) process sub-module 1306, and financial calculator sub-module 1307 provide corresponding operations for business customers.

The residential and business market manager modules 1302, 1305 interact with a number of other modules that provide specialized functionality. An interactive communicator module 1308 provides a communication interface between platform 1301 and residential customers 1309 and/or business customers 1310. The interactive communicator module 1308 may provide a communication portal to users via one or more of telephone, email, text, social media, websites, smartphone applications, or any other media appropriate for access network 1311. Interactive communicator module 1308 is used to initiate, receive, and/or confirm customer requests, negotiate alternative delivery times, provide customer request status updates, contact potential customers to stimulate additional requests, and any other communication between the platform 1301 and the customers.

An interactive scheduler module 1312 assists in scheduling customer requests, proposing alternative delivery times, and identifying times for potential new request stimulation. The interactive scheduler may work with an order stimulation module 1313 that identifies target customers to generate additional delivery requests. A customer relationship management (CRM) module 1314 may also be used to identify current or potential customers for new business stimulation. Customer relationship management module 1314 may be part of platform 1301 or may be a separate system.

Dynamic route optimizer module 1315 works with the interactive scheduler module 1312 to create an initial baseline route plan. The dynamic route optimizer module 1315 also provides updates to the route plan to serve additional customer requests. The dynamic route optimizer module 1315 may use information from a navigation or GPS system 1316 to determine a current location of a delivery vehicle. The navigation or GPS system 1316 may be part of the integrated delivery platform 1301 or may be a separate component that directly or indirectly provides location information for one or more delivery vehicles.

Just-in-time operations module 1317 provides instructions to employees 1318. The instructions may include, for example, route information, driving directions, product preparation instructions, point-of-sale information for deliveries, and any other appropriate information. The employees may interact with the integrated delivery platform 1301 via a just-in-time module 1317 interface, which may be a graphical user interface (GUI), keypad, printer, or any other visual, audio, or haptic interface.

Vendors 1319 may also provide inputs to—or receive instructions from—integrated delivery platform 1301. Vendors 1319 may interact with just-in-time operations module 1317 and/or interactive communicator module 1308, for example.

The integrated delivery platform 1301 further includes software code or module for optimization business logic and rules 1320 and collaboration business logic and rules 1321. Storage 1322 is used to store information required by the integrated delivery platform 1301, such as customer lists, schedules, map and routing information, inventory, product information, and the like.

At a high level of abstraction, the integrated delivery platform supports a two-step process: (1) initialization, and (2) ongoing management. Both steps have as the same business goals, which are to maximize revenue while minimizing costs, and to meet the customers' timing and other expectations. Overall, the process treats every minute wasted as a lost business opportunity and, therefore, is designed to provide route optimization, minimize windshield time (or other dead time between deliveries), and continually stimulate additional demand for any open slots. These concepts apply equally to all market segments—business, residential, special events, etc. —but may be executed in different ways in operation.

The market managers 1302, 1305 are configured so that if slots open up after initialization, then those slots are filled quickly. In one embodiment, the market managers 1302, 1305 may identify pre-qualified customers or high-interest targets that can be contacted on short notice to fill newly opened slots and, therefore, minimize otherwise lost time and sales. To anticipate and account for inevitable changing conditions, the platform 1301 continually maximizes the revenue-capability of the operator and delivery vehicle(s) throughout the business day. If any time slots become available for any reason, the integrated delivery platform attempts to fill the slot quickly with the best next alternative and to seek continual revenue production at the least cost.

For example, business market manager 1305 maximizes revenue opportunity per day while concurrently minimizing dead time through explicit consideration of potential revenue at each location and route optimizations between locations. Additionally, manager 1305 pre-positions additional targeted customers for dynamic replacement of canceled orders or other schedule “holes.” The targeted customers are added to the schedule using dynamic and interactive scheduling. In one scenario, when an existing business customer closes or moves out of the territory, then a permanent slot is opened and new potential customers should be pre-identified so that they can be contacted to fill the cancelation slots. In other scenarios, existing customers may be offered additional visits, such as a second visit in a given month, to quickly fill the cancelation slot.

The platform would be ready to target other customers in close proximity to the cancelation client using targeted stimulation such as by sending out inquiries to a set potential back-fill clients. The back-fill clients set may be selected using optimization considerations based upon, for example, a distance from the canceling customer, and an employee size relative to the slot that became available. The interactive scheduler and interactive communicator may identify and communicate with the target back-fill customers in an iterative process to fill any revenue gap.

Other embodiments include methods for delivering items to a plurality of customers. An initial delivery schedule is established by a delivery service provider. The initial delivery schedule comprises a plurality of slots representing committed delivery times and delivery locations for the customers. The items are intended to be delivered to each of the customers at an assigned delivery location no later than the committed delivery time.

The delivery service provider may determine that the committed delivery time for a selected customer is not economically optimal, such as a delivery that would require an extra trip or that would make it difficult to meet other delivery commitments. The delivery service provider may offer the selected customer an alternative delivery time that is later than the committed delivery time. For example, the alternative delivery time may be chosen to reduce delivery costs associated with the selected customer, such as a time that can be fit into an existing schedule without requiring an extra trip or extra delivery vehicle. The initial delivery schedule may be revised if the selected customer accepts the alternative delivery time.

In other embodiments, a neural system is used to continuously access supply and demand for the delivery of items to customers. The neural system identifies conflicts among customer requests for delivery and/or identifies open slots in a delivery schedule. The neural system identifies target customers that may fill the open slots. The target customers are selected from a list of potential customers based upon the target customers' locations and the locations of existing customers. The neural system contacts the target customers to stimulate additional delivery requests to fill the open slots.

The neural system may comprise, for example, a processor operating as a “brain” that continuously obtains relevant data, such as a current schedule and potential customers. The processor assesses that data and makes decisions to further optimize the schedule. The brain triggers actions to stimulate additional delivery request from the potential customers.

In one embodiment, an initial lunch or business delivery schedule may use a method for identifying and scheduling locations for recurring delivery services. A system, such as an integrated delivery platform, automatically identifies target properties within a target area. The target area may be any geographic area, such as a municipal boundary, service area, or assigned territory. The target properties are selected using parameters that are based upon distances between the properties and potential revenue from the properties. The target properties may be identified based upon an expected rate at which the properties will request the delivery service in response to a stimulated request (i.e. a “take rate” or acceptance rate).

The system stimulates requests for the delivery services from the target properties within the target area. The requests may be stimulated by, for example, a telephone call, an electronic mail message, or a text message sent to tenants of the target properties. The system may offer one or more available delivery times to a property tenant, wherein the available delivery times are selected based upon a distance between a selected property and a previously scheduled property.

The system receives requests from the target properties for the delivery services at proposed times. The system then automatically evaluates each of the proposed times to generate a delivery schedule by accepting requested times or identifying alternative times using a customer collaboration process. The delivery schedule may be generated to optimize sales at selected properties in consideration of travel time between properties.

The system may provide property information associated with the target properties, the information retrieved from a property database. The property information may include an employee count for one or more tenants at the property, a list of tenants at the property, a list of service facilities at the property, and/or a list of service facilities within a designated distance of the property, for example.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

1. A method for delivering items to a plurality of customers, comprising:
establishing an initial delivery schedule comprising a plurality of slots representing delivery times and delivery locations for the customers, wherein the items are to be delivered to each of the customers at an assigned delivery time and delivery location, the assigned delivery time resulting from a collaborative negotiation with the customer;
identifying, by a computer system, a set of pre-selected additional customers for possible scheduling of any open slot;
automatically identifying in real-time an additional slot in the initial delivery schedule, the additional slot representing a capacity to provide the item to one or more additional customers; and
contacting one or more target customers to fill the additional slot, wherein the target customers are automatically selected from the set of pre-selected additional customers based upon at least a target customer location relative to delivery locations associated with the slots adjacent to the additional slot.

2. The method of claim 1, further comprising:
receiving new customer requests for the items;
based upon the real-time capacity to deliver the items, using an automatic collaborative process to establish a new slot for the new customer;
updating the initial delivery schedule when the new customer has accepted the new slot; and
using the automatic collaborative process to identify alternative slots for the new customer when the new customer has not accepted the new slot.

3. The method of claim 1, further comprising:
receiving real-time delivery vehicle location information from a navigation system; and
using the real-time delivery vehicle location information to select the target customers and further qualify the additional customer to be contacted.

4. The method of claim 1, further comprising:
providing just-in-time instructions to a delivery vehicle operator while executing the delivery schedule.

5. The method of claim 4, wherein the just-in-time instructions include one or more of preparation directions for an item to be delivered in an upcoming slot and driving directions to arrive at an upcoming slot.

6. The method of claim 1, further comprising:
providing real-time information to customers regarding an order status and an expected delivery time.

7. The method of claim 1, wherein the targeted stimulation is associated with providing the item on a current day or a future day.

8. The method of claim 1, further comprising:
scheduling a pick-up order for a customer, the pick-up order allowing the customer to pick-up items at or near a delivery time and delivery location previously scheduled for another customer or at a pick-up time at a mutually agreed-upon pick-up location.

9. The method of claim 1, wherein establishing the initial delivery schedule further comprises:
generating an optimized delivery route that is selected to minimize driving time between delivery locations.

10. The method of claim 1, further comprising:
dynamically generating in real-time an updated delivery route in response to scheduling of a target customer in an additional slot or a replacement customer in a cancelation slot, the updated delivery route accounting for the driving time to and from delivery locations associated with the target customer or replacement customer.

11. The method of claim 1, further comprising:
selecting target customers and potential replacement customers based upon financial calculations that consider revenue and cost impact of scheduling each customer.

12. The method of claim 1, further comprising:
storing customer information in a customer database; and
selecting the target customers and potential replacement customers from the customer database based upon the associated customer information.

13. The method of claim 1, further comprising:
receiving a neighbor delivery request that is associated with a current customer on the initial delivery schedule; and
scheduling a delivery for neighbor at or near the delivery time for the current customer.

14. A system for delivering items to customers, comprising:
a processor;
an interactive scheduler module configured to maintain a schedule of times and locations for delivering the items to a plurality of customers;
a manager module configured to continuously evaluate the schedule in real-time and identify available slots representing capacity to deliver items to one or more additional customers, the manager module further configured to identify target customers to fill the excess slots; and
an interactive communication module configured to contact the target customers to stimulate additional delivery requests for the available slots.

15. The system of claim 14, wherein the schedule is associated with delivering items to commercial locations, and wherein the manager module is configured to identify excess capacity to deliver items to additional commercial locations in the available slots.

16. The system of claim 14, wherein the schedule is associated with delivering items to residential locations, and wherein the manager module is configured to identify excess capacity to deliver items to additional residential locations in the available slots.

17. The system of claim 14, further comprising:
a dynamic route optimizer module configured to generate a delivery route for meeting the location and times on the schedule, the delivery route selected to minimize driving time between the locations; and
a just-in-time operations module configured to provide an operator with preparation directions for items to be delivered so that the items are ready at the appropriate delivery times.

18. The system of claim 14, wherein the manager module is configured to identify conflicts among two or more delivery requests for the available slots and to select customers to fill the available slots using an interactive collaborative process to optimize a revenue and expense balance for deliveries to the selected customers.

19. The system of claim 14, further comprising:
a database of potential customers accessed by the manager module to identify the target customers.

20. A method for identifying and scheduling locations for recurring delivery services, comprising:
automatically identifying target properties within a target area, the target properties selected using parameters based upon distances between the properties and potential revenue from the properties;
stimulating requests for the delivery services from the target properties within the target area;
receiving requests from the target properties for the delivery services at proposed times; and
automatically evaluating, by a computer system, each of the proposed times to generate a delivery schedule by accepting requested times or identifying alternative times using a customer collaboration process.

21. The method of claim 20, further comprising:
providing property information associated with the target properties, the information retrieved from a property database.

22. The method of claim 21, wherein the property information includes an employee count for one or more tenants at the property.

23. The method of claim 21, wherein the property information includes one or more of a list of tenants at the property, a list of service facilities at the property, and a list of service facilities within a designated distance of the property.

24. The method of claim 20, wherein stimulating requests for the delivery services further comprises:
automatically initiating one or more of a telephone call, an electronic mail message, and a text message to tenants within the target area.

25. The method of claim 20, wherein the delivery schedule is generated to optimize sales at selected properties in consideration of travel time between properties.

26. The method of claim 20, wherein stimulating requests for the delivery services further comprises:
offering one or more available delivery times to a property tenant, wherein the available delivery times are selected based upon a distance between a target selected property and a previously scheduled property.

27. The method of claim 20, further comprising:
identifying the target properties based upon an expected rate at which the properties will request the delivery service in response to a stimulated request.

28. The method of claim 20, wherein the target area is selected based upon an assigned service territory.

29. (canceled)

30. (canceled)
